(19) United States
(12) Patent Application Publication
(10) Pub. No.: US 2010/0321433 A1
(43) Pub. Date: Dec. 23, 2010

(54) MULTI-CHIP PRINTHEAD ARRAY WITH REDUCED NOZZLE OFFSET

(76) Inventors: George Keith Parish, Winchester, KY (US); Timothy Lowell Strunk, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/486,845

(22) Filed: Jun. 18, 2009

(51) Int. Cl. B41J 29/38; B41J 2/145

(52) U.S. Cl. 347/12; 347/40

(57) ABSTRACT

A pagewide array of inkjet printheads arranged to reduce nozzle offset. The row of nozzles of each printhead are formed adjacent an edge of the semiconductor chip. Each alternate printhead chip is rotated 180 degrees with regard to its neighbor, thereby reducing the nozzle offset. A smaller nozzle offset minimizes the dot displacement error should the print medium be skewed with respect to the array of printheads.

### CROSS REFERENCES TO RELATED APPLICATIONS

None.

### BACKGROUND

1. Field of the Invention

The present invention relates generally to inkjet printers and, more particularly, to multi-chip inkjet printheads adapted for pagewide printing applications.

2. Description of the Related Art

Printers are well adapted for reproducing text, images, symbols, etc., on a tangible medium. Inkjet printers are well known in the reproduction field for depositing droplets of ink on the print medium to form the text or other image. The printhead of an inkjet printer includes at least one vertical row of nozzles through which a droplet of ink is jetted onto the print medium. When addressed by the processor or controller of the printer, the printhead receives the electrical signals, decodes the same, and drives one or more heaters of the printhead to quickly heat the ink in a nozzle to nucleate the same and cause a droplet of ink to be jetted from the nozzle. Typically, there is one heater for each nozzle in a thermal inkjet printhead

Many office and home printers are constructed to successively move the printhead on a carriage laterally across the print medium, such as a sheet of paper, and jet the droplets of ink thereon. The data to be printed is rasterized so that during each printing swath, the firing of each nozzle is controlled at each dot position across the print medium. For high resolution printers, there are a larger number of nozzles that can be fired a greater number of times per unit of lateral movement of the printhead. After each lateral printing swath, the print medium is advanced in a direction perpendicular to the swath taken by the printhead. After a number of swaths, the printhead can form the desired letters, numbers or other images on the print medium. When printing color images, the printhead can be constructed with many rows of nozzles, where each row is coupled to a different reservoir or ink cartridge so that a different colored ink can be reproduced on the print medium.

While the inkjet printers of the type described above are effective in printing images on the print medium, they tend to be slow, as the printhead must be moved many times across a single sheet of the print medium in order to complete the page. While the speed of the printhead can be increased to reduce the time in which the printing operation can be completed, there are limits on the speed of the printhead. One solution to the print speed problem would be to employ a long printhead that extends across the entire width of the print medium. Thus, with this arrangement, the printhead would not move at all to print each raster line of data. Rather, a line or raster of data would be printed at one time without having to move the print medium. After the completion of each raster line, the print medium would be advanced to print another raster line of data. This is called pagewide printing. The disadvantage of this approach is that a single long printhead is very difficult to fabricate, it being realized that printheads are generally constructed with semiconductor materials and semiconductor fabrication techniques. Thus, it would be very impractical and costly to form an eight or nine inch long printhead from a semiconductor wafer for use with 8.5 inch wide paper.

Instead of utilizing a single long printhead for pagewide printing applications, those skilled in the art have found that a number of individual printheads can be mounted on a long support medium that extends the width of the print medium. The printheads can be aligned together, end to end, so as to effectively provide a nozzle at each possible dot location. For high resolution printers, there may be hundreds of dot locations, and thus inkjet nozzles, for every inch of lateral printable area of the print medium. The nozzles at the opposite ends of each printhead must be very close to the respective edges so as to provide a nozzle for each dot location. In other words, with each printhead placed end-to-end in a series, the last nozzle of one printhead and the first nozzle of the next printhead must be spaced apart the same distance as the resolution of each dot location. Otherwise, there would be one or more missing printable dot locations without a corresponding nozzle. Obviously, the fabrication of semiconductor printheads with the nozzle structures so close to the ends of the chip is also impractical.

In order to address the problems of fabricating nozzles close to the end edges of the printhead chips, U.S. Pat. No. 6,843,551 discloses a technique for fabricating inkjet printheads in a parallelogram shape. With this construction, the printheads can apparently be placed end-to-end and provide an inkjet nozzle at every printable dot location, Nevertheless, alignment of the series of printhead chips is critical in forming high quality raster lines of data.

U.S. Pat. No. 6,994,420 discloses a technique for employing multiple printheads to provide pagewide printing of text and images. The printheads are mounted to a support that extends across the width of the print medium. However, according to this technique, every other printhead is offset from the others so that the chips themselves can be longer than the row of nozzles formed therein, and the nozzles need not be formed near the opposite edges of the chips. However, as will be described in more detail below, the offset nature of every other printhead chip can cause visible printing errors if the printhead chips themselves, or the support to which the chips are mounted, are not exactly orthogonal to the paper feed path of the print medium. If the paper is fed to the printheads even at a small angle, the raster line of ink dots can appear either more dense or less dense, or both, at the stitch boundaries where the nozzles of one printhead end and the nozzles of the adjacent printhead begin An angle of error between the print medium and the printhead array of even one degree can result in a visible difference in the ink dot pattern. In addition, the more offset the alternate printheads from the others, the more noticeable the error in the dot pattern, for a given skew angle between the print medium and the printhead array. Accordingly, while the placement of the individual inkjet printheads in an offset manner solves one problem, another problem is created.

From the foregoing, it can be seen that a need exists for an innovation that allows an array of inkjet printheads to be employed in an offset manner, but yet reduces the displacement error in the printed dot pattern, for given skew angles. Another need exists for reducing the amount of offset between the alternated printheads, thus reducing the displacement error between the dot pattern at the stitch boundaries. Yet another need exists for an inkjet printhead that is fabricated with the row(s) of nozzles adjacent an edge of the printhead chip, to facilitate a reduction in the offset between printheads. Another need exists for a technique that allows alternate printheads to be rotated 180 degrees so that the offset between the nozzles of the different printheads is minimized,

### SUMMARY OF THE INVENTION

The present invention meets these needs by providing an innovation that reduces the nozzle offset between staggered printheads of an array, thereby minimizing dot displacement errors should the paper feed path be skewed with respect to the array of printheads.

Accordingly, in an aspect of the present invention, a printhead is constructed with at least one row of nozzles offset from a longitudinal centerline of the printhead chip.

Accordingly, in another related aspect of the present invention, a printhead is constructed with a row of nozzles adjacent a longitudinal edge of the printhead chip,

In another aspect of the present invention, a number of the printhead chips are arranged in an array in a staggered or offset manner, with alternate printhead chips rotated 180 degrees from the neighbor chips

In an exemplary embodiment of the present invention, a pagewide printhead arrangement includes plural printheads, where each printhead has at least one row of nozzles formed offset from a longitudinal centerline of the printhead, and the printheads are arranged so that alternate positioned printheads are rotated 180 degrees. With this arrangement, the offset between all of the rows of nozzles of all the printheads is minimized. With a smaller nozzle offset, the dot placement error is minimized should there be a skew between the paper feed path and the array of printheads.

### BRIEF DESCRIPTION OF THE DRAWINGS

Having thus described the invention in general terms, reference will now be made to the accompanying drawings, which are not necessarily drawn to scale, and wherein:

FIG. 1 illustrates a dot pattern printed on a print medium by an array of offset printheads according to prior art techniques.

FIG. 2 is a bottom view of a prior art printhead of the type utilized to print the dot pattern of FIG. 1.

FIG. 3 illustrates a dot pattern printed on a print medium by an array of offset printheads, where the paper is skewed at a slight angle with respect to the printhead array, and where the enlargements show the displacement errors in the dot patterns at the stitch boundaries.

FIG. 4 graphically illustrates the displacement errors in the dot pattern versus the offset between the printhead nozzles, and as a function of different skew angles.

FIG. 5 graphically illustrates the printhead offset versus the skew angle, as a function of different displacement errors.

FIG. 6 is a bottom view of a printhead constructed according the principles and concepts of the invention.

FIG. 7 illustrates an array of the inkjet printheads arranged in an offset manner, but where the offset between the nozzle rows is significantly reduced, thus reducing the displacement errors in the dot pattern even with significant skew angles.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

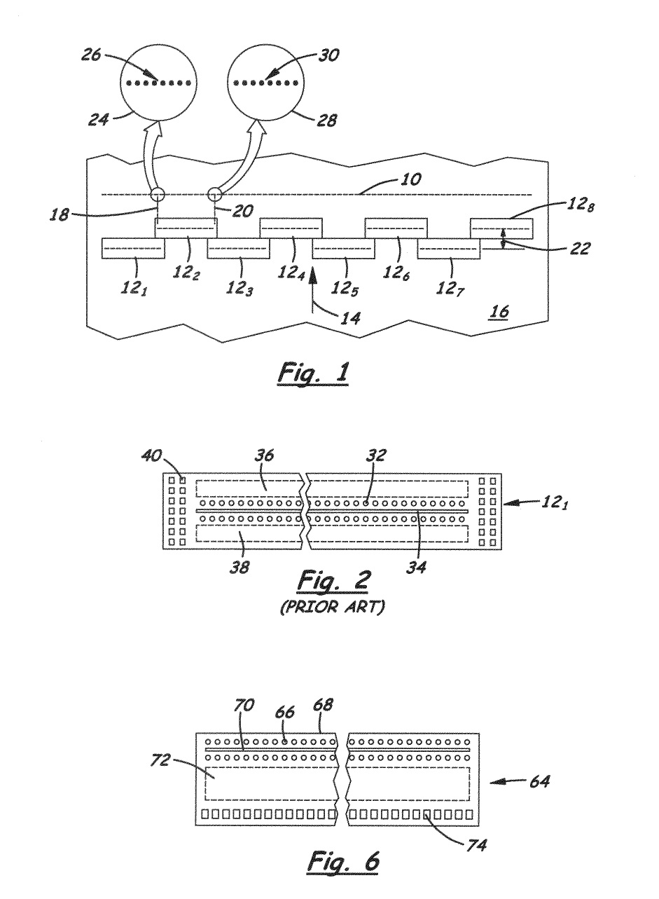

Referring now to FIG. 1, there is illustrated a dot pattern 10 printed with an array of inkjet printheads 12₁-12₈ mounted to a support (not shown) so as to be orthogonal to the paper feed path, shown by arrow 14. Each printhead 12₁-12₈ is adapted for printing a respective segment of the dot pattern 10. For purposes of illustration, the dot pattern 10 is a single line of inkjet dots printed on a paper medium 16. The single, continuous line 10 is printed by first firing the nozzles of the even-numbered printheads 12₂, 12₄, 12₆ and 12₈ to print respective segments of the line 10. The print medium 16 is then advanced by an amount equal to the nozzle offset 22, and then the jets of the odd-numbered printheads 12₁, 12₃, 12₅ and 12₇ are fired to print the remaining segments of the line 10. A single continuous line 10 of ink dots can thus be printed. In practice, a single line is generally not printed, but the various jets of the various printheads are selectively fired to print text, numbers or other images. Moreover, not all nozzles would be fired at the same time, but fired in short sequences to manage the electrical and thermal energy required to drive the thermal inkjet printheads 12.

A stitch boundary exists between each dot location where the nozzles of one printhead end and the nozzles of the next printhead begin. One stitch boundary is illustrated by numeral 18, and the next stitch boundary is illustrated by numeral 20. The other stitch boundaries of the dot pattern 10 are not identified. The offset between the printheads is illustrated by arrow 22, which is the distance between the nozzles of one printhead, such as printhead 12₇, and the nozzles of the adjacent offset printhead, such as printhead 12₈. If the nozzles are formed generally around the longitudinal centerline of the respective printhead chips, the offset 22 can be about the same as the width of a printhead chip 12 When the alignment between the array of printheads and the paper feed path 14 is exactly orthogonal, the spacing between the inkjet dots is uniform throughout the entire length of the printed line 10. The uniform spacing between the inkjet dots at the stitch boundary 18 is illustrated in the enlargement of circle 24. The inkjet dots at the stitch boundary 18 are shown by the arrow 26. The uniform spacing between the inkjet dots at the stitch boundary 20 is illustrated in the enlargement of circle 28. The inkjet dots at the stitch boundary 20 are shown by the arrow 30

FIG. 2 is a bottom view of the printhead 12₁ constructed according to the prior art. The other printheads 12₂-12₈ are constructed in an identical manner. The printhead 12₁ is fabricated in a semiconductor wafer using semiconductor techniques to form micron size features. One or more rows of nozzles are formed in the printhead, one row shown as numeral 32. Another row of nozzles is typically located on the other side of the ink via 34, as shown. An ink via 34 is provided adjacent the nozzles 32 to supply each nozzle with liquid ink. While not shown, a nozzle plate is placed over the nozzles 32 and the via 34 of the semiconductor printhead 12, with the holes of the nozzle plate aligned with the respective printhead nozzles 32. For ease of construction, the nozzles 32 are generally formed near the center of the printhead 12₁. Logic circuits are formed in the wafer areas 36 and 38 located on each side of the nozzle structures 32. The logic circuits can include address processing and decode circuits, shift registers, as well as other circuits. The I/O circuits can include input/output bond pads, one shown as numeral 40. As can be appreciated, with the construction of the prior art printheads, the nozzle offset can be substantial, and can range between 7 microns and 8 microns. As noted above, the greater the nozzle offset, the greater the dot displacement error when the printheads are not precisely aligned orthogonal with the paper feed path 14.

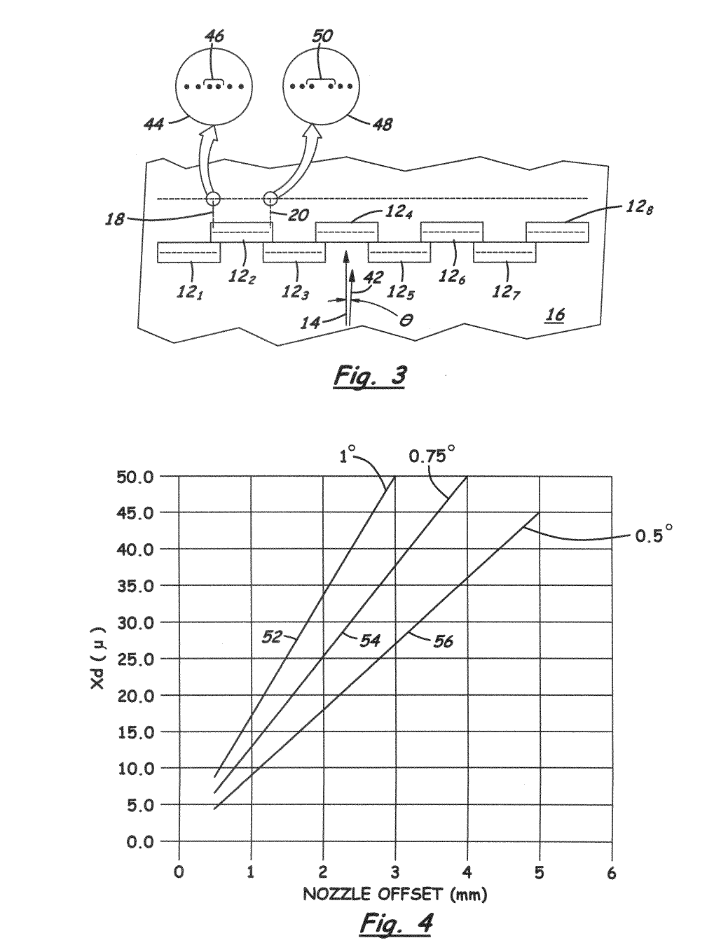

With reference now to FIG. 3, there is illustrated a situation where the actual feed path 42 of the print medium 16 is skewed by an angle 0 from the desired feed path 14, which is orthogonal to the array of printheads 12. The skewed feed path of the print medium is identified as numeral 42. The skew of the feed path 42 need be no greater than about one degree before the dot placement error becomes highly visible and objectionable. The feed path skew, together with the extent of the nozzle offset, produces a dot displacement error at the stitch boundary.

With regard to the stitch boundary l 8, the dot displacement error is shown by enlargement 44. In particular, the inkjet dots on each side of the stitch boundary 18 are closer together than the other inkjet dots. This is shown by the two inkjet dots 46. At the adjacent stitch boundary 20, the dot displacement error is shown by enlargement 48. The inkjet dots on each side of the stitch boundary 20 are further apart than the other ink jet dots. The displacement error of the inkjet dots at the stitch boundary 20 is shown by reference numeral 50. Had the print medium 16 been skewed in the other direction the same amount (-0), then the dot placement at the stitch boundary 18 would have been further apart than the neighbor dots, and the dot placement at the stitch boundary 20 would have been closer together than the neighbor dots. Attempts have been made to overcome this dot displacement error by carrying out multiple print passes, first using some of the printheads, and then in subsequent passes using the other printheads of the array.

The displacement error of the inkjet dots shown in FIG. 3 is visually manifest as a vertical concentration of dots at stitch boundary 18, which appears as a narrow vertical line on the print medium 16. On the other hand, the dot displacement error at the stitch boundary 20 is manifest as a lack of dots in a vertical direction on the print medium 16, i e., a narrow vertical space. The vertical concentration of closer-spaced inkjet dots that form a vertical line and the concentration of inkjet dots that are further spaced apart that form a vertical space are a result of the printing of many raster lines that have the same displacement errors. It is noted that there will be either a vertical line or a vertical space printed on the medium at the locations of every stitch line. The quality of print is thus compromised if there is a skew between the array of printheads and the feed path of the print medium.

FIG. 4 graphically depicts the displacement error X_{d} in microns of the dot pattern versus the offset in millimeters between the printhead nozzles, all as a function of different skew angles. Line 52 illustrates the dot displacement error at a skew angle of one degree. Line 54 illustrates the dot displacement error at a skew angle of three-fourths of a degree. Lastly, line 56 illustrates the dot displacement error at a skew angle of one-half degree. For purposes of illustration, it is assumed that the PEL of the dot pattern is 1/1200 of an inch, meaning that the spacing between the inkjet nozzles is about 1/1200 of an inch, or 42 microns. And it is further assumed that the dot displacement error X_{d} should not be any greater than the PEL, namely 42 microns. Then, if the maximum skew angle is considered as one degree, the maximum nozzle offset must be no greater than about 2.4 millimeters. As can be appreciated, with smaller degrees of skew, the nozzle displacement can be greater for a given acceptable dot displacement error.

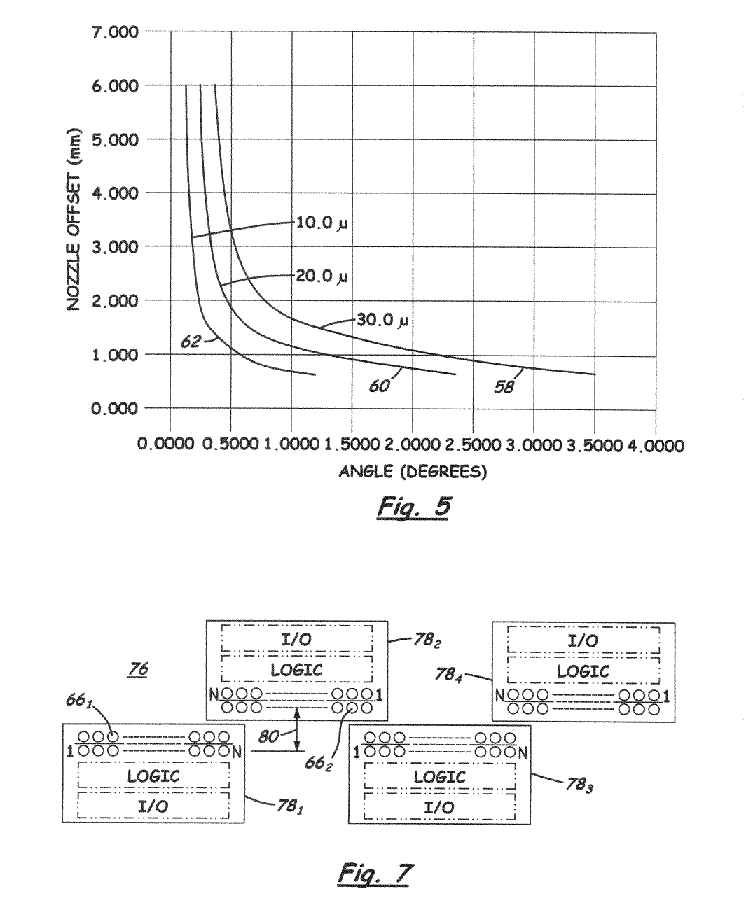

FIG. 5 illustrates the same parameters as identified above in connection with FIG. 4, but with the printhead nozzle offset versus the skew angle, as a function of different dot displacement errors. Line 58 illustrates a dot displacement error of 30 microns. Line 60 illustrates a dot displacement error of 20 microns, and line 62 illustrates a dot displacement error of 10 microns. Thus, for a maximum dot displacement error of 30 microns between ink jet dots at a stitch boundary, with a nozzle offset of three millimeters, then the skew angle should be no greater than about 0.52 degrees.

FIG. 6 illustrates a printhead 64 constructed according to the principles and concepts of the invention. The printhead 64 is constructed using semiconductor materials and fabrication techniques. Rather than placing the inkjet nozzles 66 near the longitudinal centerline of the chip, the nozzles 66 are located adjacent a longitudinal edge 68 of the printhead chip 64. As will be described below in connection with FIG. 7, the placement of the nozzles at such location allows the realization of very small nozzle offsets between adjacent printheads of an array. Other rows of nozzles can be formed adjacent and parallel to the row 66 to accommodate the jetting of different color ink droplets. In a conventional manner, an ink via 70 is formed adjacent the row of nozzles 66 to provide a supply of liquid ink thereto. In addition, shown is another row of nozzles located on the other side of the ink via 70.

The logic circuits that control the selection and firing of the nozzles 66 can be located in the semiconductor area 72, which is more or less in the center of the printhead chip 64. The I/O 74, which include the contact pads or bond pads, is preferably located along the longitudinal edge of the chip 64 opposite the nozzles 66. Thus, an efficient utilization of the semiconductor chip area is realized. While not shown, a nozzle plate with holes therein is typically placed over the bottom of the printhead chip 64 to allow the nozzles to jet ink droplets through small holes of the nozzle plate, and onto the print medium.

It is contemplated that the size of the printhead chip 64 will be about 2.0-3.0 mm by about 32.28 mm. The distance between the longitudinal edge 68 of the chip 64 and a line through the row of nozzles 66 is expected to be in the range of about 0.2 mm to about 0.5 mm. This small distance of the nozzles 66 from the edge 68 of the printhead chip 64 compares with the corresponding distance of the prior art chips 12 shown in FIG. 1, which is about 1.0 mm.

With reference now to FIG. 7, there is depicted an array 76 of four printhead chips 78₁-78₄, it being understood that other numbers of identical chips can be employed for specific applications, whether for pagewide print applications or otherwise. In practice, the shorter edges of the printhead chips 78₁-78₄ of FIG. 7 would overlap, as shown, and the ends of the longitudinal edges would contact the neighbor chips to reduce the nozzle offset. Much like the prior art techniques, the printhead chips 78₁-78₄ are staggered or offset from each other, and are identically constructed. However, the alternate printhead chips, for example the even-numbered chips 78₂ and 78₄, are rotated 180 degrees with respect to the odd-numbered printhead chips 78₁ and 78₃. This arrangement and positioning of the printhead chips takes advantage of the nozzles 66 being located adjacent the longitudinal edge 68 of the respective chips. As can be seen in FIG. 7, the offset 80 between the nozzles 661 of printhead chip 78₁, and the nozzles 66₂ of printhead 78₂ is extremely small. In the example, the nozzle offset 80 is about 1.0 mm. Indeed, the offset 80 is much less than the width of the individual printhead chips. It should be understood that the chip can have multiple rows of nozzles for multiple colors as long as the nozzle offset it acceptable.

When employing printhead chips that are constructed with multiple rows of nozzles for printing different types or colors of inks, the offset is the distance between the nozzle rows that jet the same color of ink. In other words, if the edge row of nozzles on one chip jetted cyan-colored ink, and the second row of nozzles of the adjacent rotated printhead chip also jetted cyan-colored ink, then the offset is the distance between these two rows of nozzles, as they both jet the same colored ink. In the illustration of FIG. 7, the offset 80 is shown to be the distance between the second row of nozzles from the edge of printhead chip 78₁, and the edge row of nozzles of the rotated printhead chip 78₂, as both such rows of nozzles would jet the same color of ink. If the edge row nozzles of both chips 78₁ and 78₂ printed the same color of ink, then the offset would be a shorter distance.

In the embodiment shown in FIG. 7, the printheads chips 78 are configured so that every other chip is oriented 180 degrees about a respective printhead centerline with respect to neighboring printhead chips. One of ordinary skill in the art will readily understand that other embodiments are possible whereby groups of two or more printhead chips are oriented 180 degree about a respective printhead centerline with respect to a neighboring printhead chip or with respect to a neighboring group of printhead chips.

According to the advantages of the invention, if the offset 80 between the nozzles 66 of adjacent printhead chips 78 were 2.0 micron, and the print medium skew angle were at the maximum of one degree, then the dot displacement error would be only 35 microns, which is much less than the PEL of 42 micron of the example. This conclusion is drawn from the graph of FIG. 4. According to the prior art arrangement of printheads 12 illustrated in FIG. 1, a typical offset of 5 mm and a one degree skew would result in a dot displacement error of much greater than 50 microns, and is indeed off the graph of FIG. 4. Hence, under the same conditions noted above, the prior art printhead arrangement would produce a highly noticeable and unsatisfactory print quality, while the printhead arrangement of the invention would produce a highly acceptable print quality without any visually noticeable anomalies.

The nozzles 66₁, of the printhead 78₁ are arbitrarily numbered 1-N from left to right, while the nozzles 66₂ of printhead 78₂ are numbered N-1 from left to right. This is because the printhead chips 78₁ and 78₂ are identically constructed, but rotated 180 degrees with respect to each other. Accordingly, the printer controller can be programmed to map the nozzle addresses of the printheads 78₁ and 78₃ differently from the nozzle addresses of printheads 78₂ and 78₄. Stated another way, and neglecting the portion of the address that selects or identifies the particular printheads themselves, the address of nozzle 1 of printhead 78₁ would be different from the address of nozzle N of printhead 78₂, even though both nozzles are the left-most nozzles of the chips in the array 76 of printheads.

From the foregoing, disclosed is an arrangement of inkjet printheads that can be employed in pagewide applications, and where the print quality is much improved as a function of skew between the printhead array and the print medium. The inkjet dot displacement error is significantly reduced by minimizing the offset between the staggered printheads. The offset between the staggered printheads is reduced by forming the nozzles of each printhead chip close to a longitudinal edge of the respective chips, and then rotating every other printhead chip in the staggered array by 180 degrees. This results in a minimal nozzle offset in the direction of paper feed, and thus minimal dot displacement errors

It should be understood that while the array of FIG. 7 illustrates a single staggered row of printheads, there can be a staggered row of printheads for each color to be utilized during the printing process. In addition, the dimensions and other particulars of the printhead and array of the invention are set forth only as an example, as many other dimensions and other details can be utilized without departing from the scope of the invention. The printhead chips of an array need not be identical, but the various chips of an array can incorporate differences so as to circumvent problems that arise. It should also be noted that while the problem described above involves the skew of the paper feed path with respect to the array of printheads, the same problem is involved when the one or more printheads is not aligned with the others or when the entire array itself is skewed from a desired orientation.

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

What is claimed is:

1. A method of arranging multiple inkjet printheads in an array to reduce a nozzle offset thereof, said nozzles adapted for ejecting ink therefrom onto a print medium, comprising:
using multiple inkjet printheads, each with at least one row of nozzles displaced from a centerline of the respective printhead;
arranging the printheads in an array so that a dot pattern of ink produced by each said printhead is parallel with each other; and
orienting alternate printheads of the array 180 degrees about a respective printhead centerline with respect to neighbor printheads.

2. The method of claim 1 further including locating the row of nozzles of each said printhead adjacent a longitudinal edge of the respective printheads.

3. The method of claim 1 further including forming multiple rows of nozzles in each said printhead.

4. The method of claim 1 further including mounting the array of inkjet printheads on a support

5. The method of claim 4 further including fixing the support against movement during printing.

6. The method of claim 1 further including arranging said inkjet printheads so that the nozzle offset is less than about 2.0 mm.

7. The method of claim 1 further including arranging said inkjet printheads so that the nozzle offset is less than a width of said printhead.

8. The method of claim 1 wherein the step of orienting alternate printheads of the array 180 degrees about a respective printhead centerline comprises alternating a pair of printheads of the array about a respective printhead centerline with respect to a neighbor pair of printheads.

9. The method of claim 1, further including forming each said printhead on a different semiconductor chip.

10. A method of arranging multiple inkjet printheads in an array to reduce a nozzle offset thereof, said nozzles adapted for ejecting ink therefrom onto a print medium, comprising
using multiple inkjet printheads, each with at least one row of nozzles spaced from a longitudinal axis of the inkjet printhead so that the row of nozzles are located closer to one edge of the inkjet printhead than an opposite edge of the inkjet printhead;
arranging the multiple inkjet printheads on a support so that when a print medium moves with respect to the support, the multiple inkjet printheads can each print a row of ink dots which define a segment of a line, and each segment of ink dots can be printed to form a single line on the print medium; and
arranging the multiple printheads on the support with alternate positioned inkjet printheads reversed, whereby the nozzle offset is reduced.

11. The method of claim 10 further including reversing the alternate printheads by orienting the alternate printheads 180 degrees with respect to neighbor printheads.

12. The method of claim 10 further including using printheads each with plural rows of nozzles.

13. The method of claim 10 further including addressing individual nozzles of the alternate printheads differently from the neighbor printheads.

14. The method of claim 10 further including fabricating the printheads using a semiconductor material.

15. The method of claim 10 further including locating the row of nozzles of each said printhead adjacent a longitudinal edge of the respective printheads.

16. The method of claim 10 further including arranging said inkjet printheads so that the nozzle offset is less than a width of said printhead.

17. The method of claim 10 further including arranging said inkjet printheads so that the nozzle offset is less than about 2.0 mm.

18. An array of printheads arranged to reduce nozzle offset, said nozzles adapted for ejecting ink therefrom onto a print medium, comprising:
each said printhead of said array formed in a semiconductor chip which includes a first longitudinal edge and an opposite second longitudinal edge;
said array including a first printhead chip, a second printhead chip, a third printhead chip and a fourth printhead chip;
said first printhead chip and said third printhead chip each having a row of nozzles formed adjacent the first longitudinal edge of the respective first and third printhead chips;
said second printhead chip and said fourth printhead chip each having a row of nozzles formed adjacent the second longitudinal edge of the respective second and fourth printhead chips; and
said first printhead chip and said third printhead chip are offset from said second printhead chip and said fourth printhead chip.
